(19) United States
(12) Patent Application Publication
(10) Pub. No.: US 2006/0056808 A1
(43) Pub. Date: Mar. 16, 2006

(54) Apparatus and method for controlling playback operation of digital video device

(75) Inventor: Yeo Han Yun, Pyungtaek-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/037,256

(22) Filed: Jan. 19, 2005

(30) Foreign Application Priority Data
Sep. 13, 2004 (KR) 10-2004-0073114

(51) Int. Cl. H04N 5/91

(52) U.S. Cl. 386/94

(57) ABSTRACT

Embodiments of an apparatus and method for controlling a playback operation of a digital video device determine whether to reproduce a selection according to a restriction operation characteristic such as filter rate or size. Embodiments can calculate the sum of portions to be skipped over or muted by a (e.g., clearplay) playback restriction operation using a user-defined playback restriction condition and filter table information, compare a determined filter rate of a corresponding video, and determine whether to reproduce the title according to the filter rate. Therefore, embodiments of an apparatus can prevent a user from needlessly viewing the selected video when said portions to be skipped or muted are so sustained as to effect the viewing quality (e.g., as determined by the user).

### BACKGROUND OF THE INVENTION

1. Field of the Invention

The present invention relates to an apparatus and method for controlling a playback operation of a digital video device.

2. Background of the Related Art

There are digital video devices capable of recording/storing large amounts of high-quality video data and high-quality audio data for a long period of time. For example, devices include optical disc devices such as a DVD-player and a DVD-recorder, and a Hard Disc Drive (HDD)—recorder, etc.

One of the digital video devices, for example, a DVD player, includes an optical disc 10, an optical pickup unit 11, a VDP (Video Disc Play) system 12, a microcomputer 13, an OSD (On Screen Display) generator 14, and a memory 15, etc., as shown in FIG. 1. For example, a non-volatile memory such as a flash memory may be adapted as the memory 15.

The memory 15 downloads and stores filter table information needed to perform a specific function such as a clearplay function. The clearplay function is indicative of a new playback function. It is expected that the clearplay function will be widely applied to DVD players and a variety of other digital video devices.

As shown in FIG. 2, the filter table stored in the memory 15 associates a unique title name or a title ID with a plurality of events. Each event is comprised of start-, end-, duration-, type-, and filter condition information.

For example, a first event (Event #1) associated with a title name “Super Girl” records start information “00:04:15:19”, end information “00:04:48:26”, duration information “997”, type information “Skip”, and filter condition information “Violence & Sex” therein. A second event (Event #2) records start information “00:04:51:26”, end information “00:04:58:26”, duration information “210”, type information “Skip”, and filter condition information “Violence & Death” therein.

In the meantime, if the optical disc 10 is loaded in the digital video device, the microcomputer 13 checks a title name or a title ID by referring to navigation information of the optical disc 10. For example, if the title name (e.g., Super Girl) of the optical disc 10 is equal to another title name (e.g., Super Girl) managed by a filter table contained in the memory 15, the microcomputer 13 carries out a series of clearplay functions by referring to corresponding event information. For example, the clearplay function automatically skips over duration of data corresponding to a user-defined filter condition such as a “Violence” or “Sex”, or mutes a playback audio signal.

If time code (Timecode) information counted during a data playback operation is equal to start information “00:04:15:19” (hr:mm:sec:frame) of the first event (Event #1) on the condition that the user determines a condition of “Violence & Sex” to be a filter condition as shown in FIG. 2, the microcomputer 13 controls operations of the VDP system 12. Accordingly, the microcomputer 13 suspends the playback operation and automatically carries out a skip operation.

Thereafter, when time code information equal to end information of the first event (Event #1) “00:04:48:26” (hr:mm:sec:frame) is counted or a skip function for skipping over the duration of the “997” frame is completed, the microcomputer 13 re-performs the playback operation from a corresponding position.

The microcomputer 13 automatically skips over or mutes some duration of tide information equal to the user-defined filter condition (e.g., Violence, Sex, . . . ) by referring to information recorded in the filter table. Accordingly, the microcomputer 13 prevents video and audio data of some duration, in which unhealthy video and audio data inappropriate for adolescents or children is stored, from being freely exposed to the adolescents or children.

However, as described above, the related art clearplay operations have various disadvantages. For example, if there are too many durations in which data must be automatically skipped over or audio data must be muted according to the clearplay operation, the user is unable to correctly recognize contents of the corresponding tide, such that there is little point in reproducing the title.

The above references are incorporated by reference herein where appropriate for teachings of additional or alternative details, features and/or technical background.

### SUMMARY OF THE INVENTION

An object of the invention is to solve at least the above problems and/or disadvantages or to provide at least the advantages described hereinafter.

Another object of the present invention is to provide an apparatus and method for controlling a playback operation of an optical disk device for title according to a user-defined filter condition.

Another object of the present invention is to provide an apparatus and method for determining whether to reproduce title on the basis of a filter rate of the title detected according to a user-defined filter condition.

Another object of the present invention is to provide an apparatus and method for detecting a duration of a portion of a video stream, reproduction of which is to be controlled by a restriction operation and determining whether to reproduce the video stream according to a filter rate of the restriction operation.

In order to achieve at least the above objects and advantages in a whole or in part, in accordance with one aspect of the present invention there is provided a method for controlling a playback operation of a digital video device that includes comparing restriction information of segments of a video program with at least one restriction condition managed by the digital video device, restricting segments of the video program according to the comparison and calculating a total of the restricted segments corresponding to said at least one restriction condition.

To further achieve at least the above objects and advantages in a whole or in part, in accordance with one aspect of the present invention there is provided a method for controlling a playback operation of a digital video media contents reproduction device that includes searching for management information of a plurality of durations of first media contents, reproduction of which is restricted according to at least one playback restriction condition from among a plurality of playback restriction, and determining whether to perform a playback operation of the first media contents by referring to the retrieved management information.

To further achieve at least the above objects and advantages in a whole or in part, in accordance with one aspect of the present invention there is provided an apparatus for controlling a playback operation of a digital video device that includes a memory configured to store filter table information required for a restricted playback operation, a generator configured to generate an OSD (On Screen Display) menu image for use in a user interface, and a detector configured to detect a plurality of segment durations of a selected video, reproduction of which is restricted by the restricted playback operation, and calculate a sum of the detected durations.

To further achieve at least the above objects and advantages in a whole or in part, in accordance with one aspect of the present invention there is provided a digital video apparatus that includes a memory configured to store filter table information required for a restricted replay operation, a generator configured to generate an OSD (On Screen Display) menu image for use in a user interface, and a controller configured to detect management information of a plurality of durations of first media contents reproduction of which is restricted according to at least one restriction condition of the restricted replay operation, and determine whether to perform the restricted replay operation of the first media contents by referring to the retrieved management information.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating a related art DVD player;

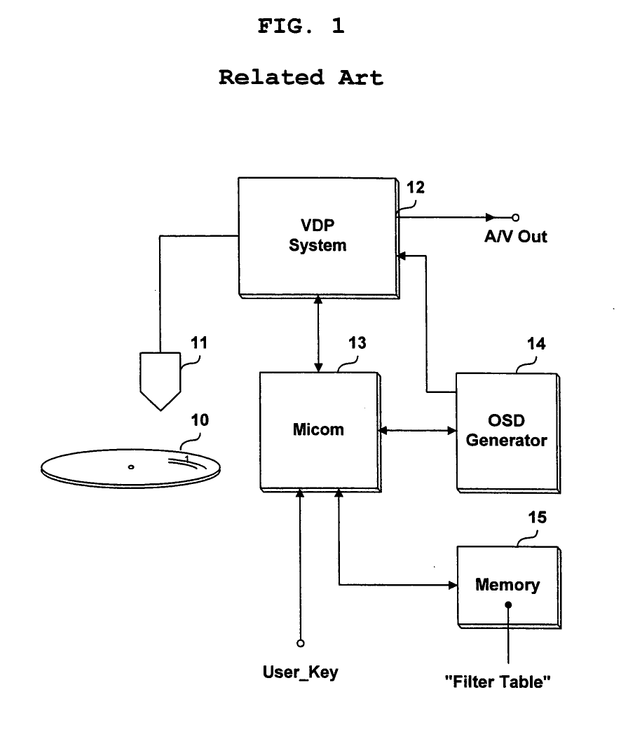

FIG. 2 is a structural diagram illustrating a filter table needed to perform a related art clearplay operation;

FIG. 3 is a block diagram illustrating a DVD player in accordance with a preferred embodiment of the present invention;

FIG. 4 is a diagram illustrating an exemplary process for detecting a filter rate in accordance with a preferred embodiment of the present invention;

FIG. 5 is a structural diagram illustrating an exemplary OSD image displayed on a screen in accordance with a preferred embodiment of the present invention;

FIG. 6 is a flow chart illustrating a method for controlling a playback operation of a digital video device in accordance with a preferred embodiment of the present invention;

FIG. 7 is a structural diagram illustrating an exemplary OSD image for informing a user of a suspended automatic playback state in accordance with a preferred embodiment of the present invention;

FIG. 8 is a structural diagram illustrating an exemplary filter table in which filter rate information is further recorded in accordance with another preferred embodiment of the present invention; and

FIG. 9 is a structural diagram illustrating a filter table in which filter size information is further recorded in accordance with yet another preferred embodiment of the present invention.

### DETAILED DESCRIPTION OF PREFERRED EMBODIMENTS

Embodiments according to the present invention can be applicable to a variety of digital video devices, for example, optical disc devices such as a DVD-player and a DVD-recorder, and a Hard Disc Drive (HDD)—recorder, etc.

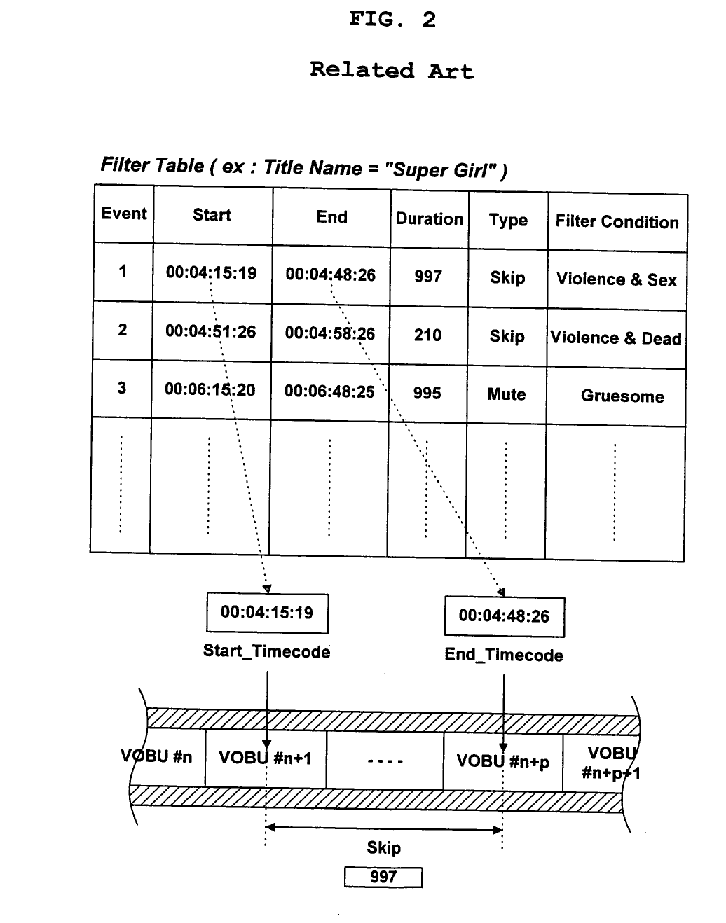

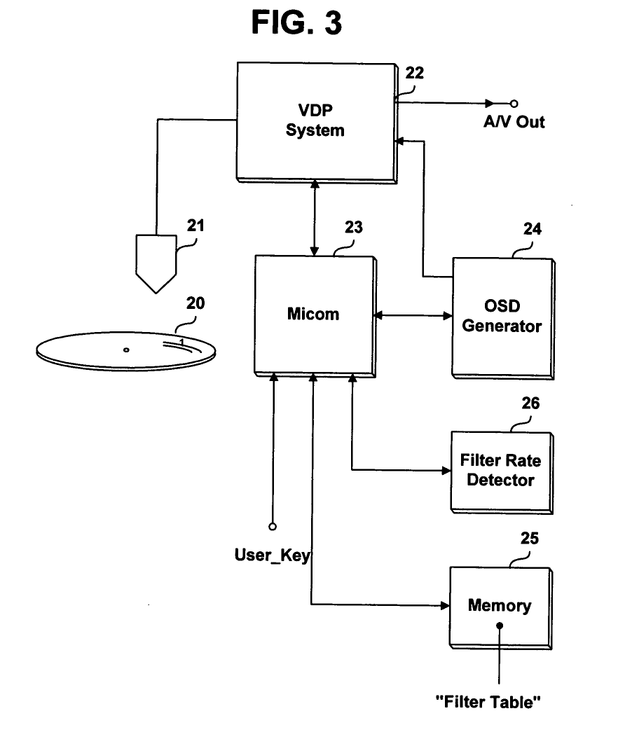

As shown in FIG. 3, a DVD player according to an embodiment of the present invention can include an optical disc 20, an optical pickup unit 21, a VDP system 22, a microcomputer 23, an OSD generator 24, a memory 25, and a filter rate detector 26, etc. As shown in FIG. 3 the memory 25 can download and store filter table information such as shown in FIG. 2. The microcomputer 23 can compare a user-defined filter condition (e.g., Violence, Sex, . . . ) with filter table information stored in the memory 25, and perform a replay operation such as a clearplay function capable of directly or automatically skipping over or muting some duration of a specific title equal to the filter condition.

The filter rate detector 26 can detect a filter rate. For example, the filter rate detector 26 can detect a plurality of durations of a selected or specific title, which are automatically skipped over or muted according to a control signal of the microcomputer 23, calculate the sum of the durations, and compare the sum of the durations with an overall duration of the specific title.

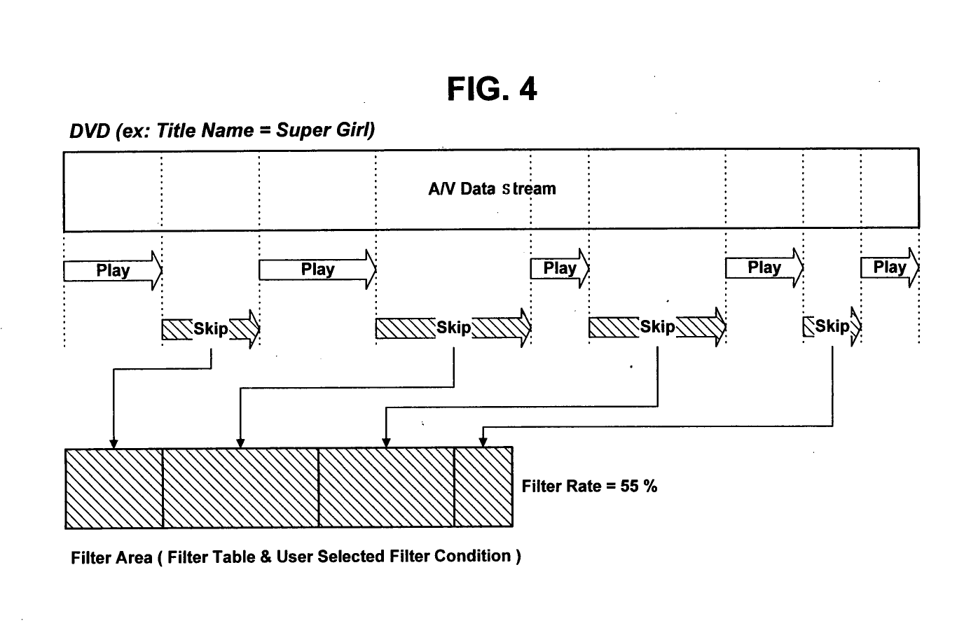

For example, as shown in FIG. 4, if an exemplary playback operation is requested on the condition that a DVD having a title name “Super Girl” is loaded in the device, the filter rate detector 26 can search for event information, which is associated with the title name “Super Girl” from among the filter table information stored in the memory 25 and determine which information is simultaneously consistent with a user-defined filter condition. After the sum of durations that are to be skipped over or to be muted according to a restriction function or a clearplay function is calculated, the filter rate detector 26 can compare the sum of durations with the overall duration of the specific title, such that it detects a filter rate (e.g., Filter Rate=55%).

The microcomputer 23 can determine whether the detected filter rate is higher than a predetermined reference value (e.g., Ref_Filter Rate=50%). The microcomputer 23 can then determine whether to perform a playback operation according to the determined result.

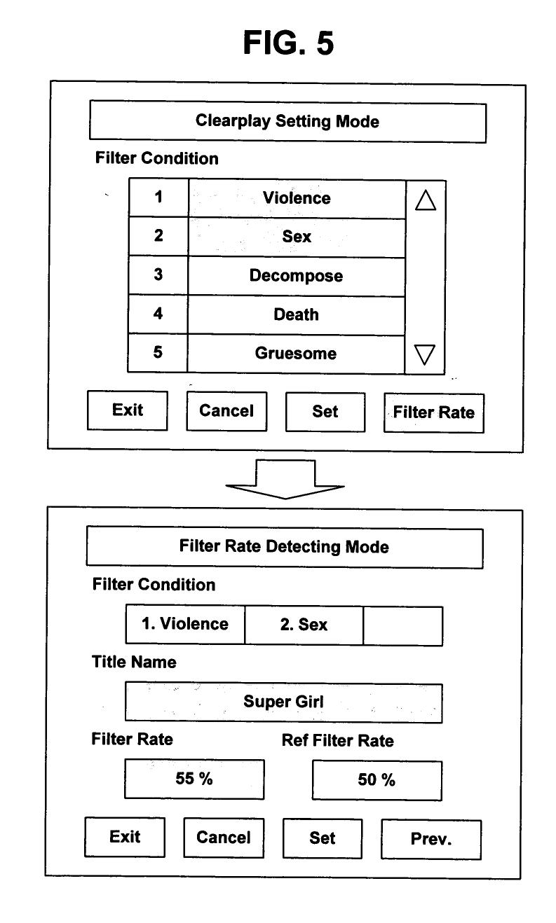

The OSD generator 24 can generate a variety of OSD menu images according to a control signal of the microcomputer 23, and display the generated OSD menu images on a screen. For example, a “Clearplay Setting Mode” menu image shown in FIG. 5 can include a plurality of menu items for selecting or entering a filter condition, which will be skipped over or muted by a user, and a specific menu item (e.g., Filter Rate) for detecting a filter rate.

If the user selects the filter rate item, the OSD generator 24 can display the user-defined filter condition (e.g., Violence, and Sex) and a title name (e.g., Super Girl) according to a control signal of the microcomputer 23. At the same time, the OSD generator can display a filter rate (e.g., Filter Rate=55%) detected by the filter rate detector 26 and a predetermined reference filter rate (e.g., Ref_Filter Rate=50%).

Therefore, the user can easily determine his or her desired filter conditions through the use of an OSD menu image, can check a filter rate of durations, in which data is automatically skipped over or muted according to the determined filter conditions, and can determine whether to reproduce a corresponding tide by adjusting the reference filter rate (e.g., Ref_Filter Rate). Such operations will now be described.

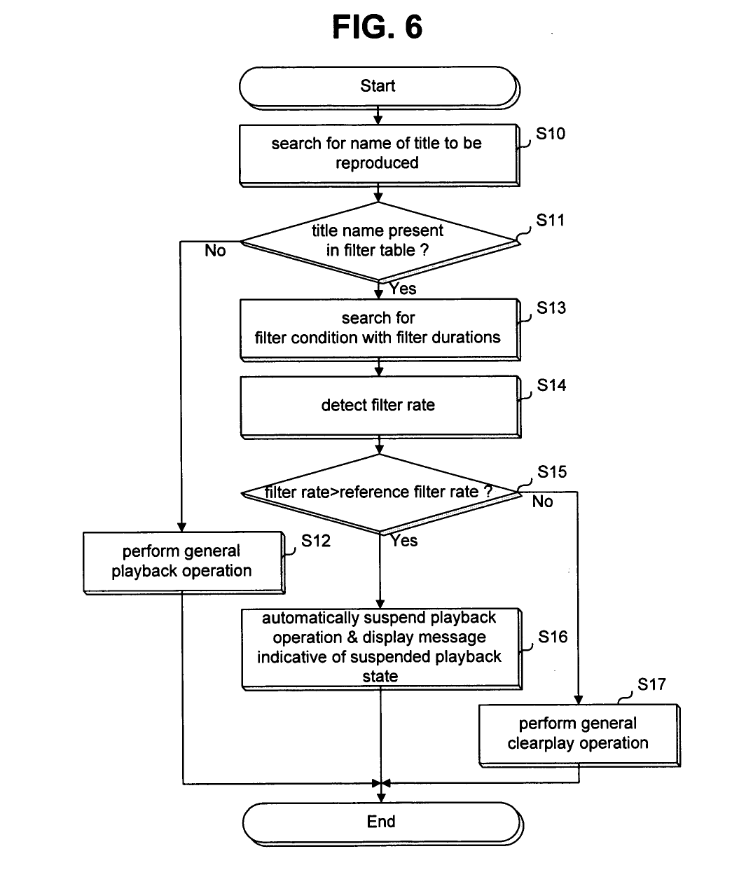

FIG. 6 is a flow chart illustrating a method for controlling a playback operation of a digital video device in accordance with an embodiment of the present invention. The embodiment of FIG. 6 can be applied to and will be described using the apparatus of FIG. 3. However, the present invention is not intended to be so limited.

When the optical disc 20 such as a DVD is loaded in the device, the microcomputer 23 can read navigation information recorded in a Lead-In area of the optical disc 20, download the read navigation information to the memory 25, and recognize a title name to be reproduced at (block S10). The microcomputer 23 can determine whether the recognized tide name is present in filter table information managed by the memory 25 at (block S11).

If the tide name to be reproduced (e.g., Super Girl) is not present in the filter table information, the microcomputer 23 can control the VDP system 22, and perform a general playback operation for sequentially reproducing a corresponding tide at (block S12). In the meantime, if the title name to be reproduced is present in the filter table information, the filter rate detector 26 can check a user-defined filter condition (e.g., Violence, and Sex), and detect specific duration equal to the filter condition, (e.g., specific duration) to be automatically skipped over or muted according to the clearplay operation, from the filter table information at (block S13).

The filter rate detector 26 can calculate the sum of durations detected, for example as described above, compare the sum of durations with the overall duration of a corresponding tide (e.g., Super Girl), and detect a filter rate (e.g., Filter Rate=55%) at (block S14). The microcomputer 23 can determine whether the detected filter rate is higher than a predetermined reference value (e.g., Ref_Filter Rate=50%) at (block S15).

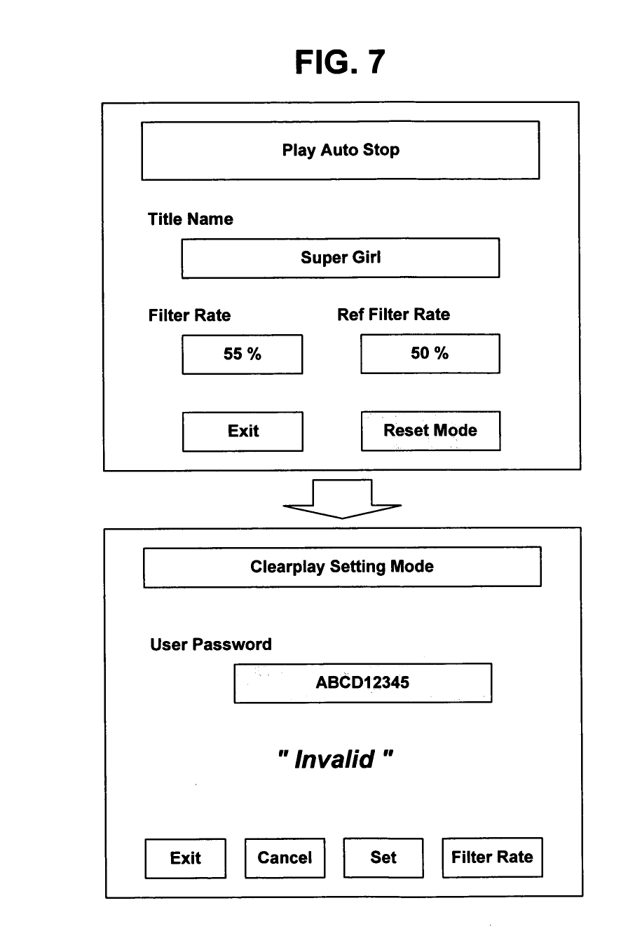

For example, if the filter rate is determined to be 55%, and the reference value is 50%, the microcomputer 23 can automatically or directly suspend the replay (e.g., clearplay) operation, or control the OSD generator 24 to display an OSD image indicative of a suspended automatic playback state (e.g., a “Play Auto Stop” state) as shown in exemplary FIG. 7 at (block S16). The OSD image may include corresponding title name information, filter rate information, and reference filter rate information.

The OSD image may further include a menu item (e.g., Reset Mode) for entering a restriction replay (e.g., clearplay) setting mode. If the “Reset Mode” item is selected, the OSD generator 24 can display a menu image of the clearplay setting mode as shown in FIG. 7. In this case, a user password entry window can be displayed such that a user authentication procedure can first be carried out.

Otherwise, if the filter rate is equal to or less than the predetermined reference value at (block S15), the microcomputer 23 can control the VDP system 22 to reproduce a corresponding title, and at the same time performs a series of restriction operations or clearplay operations for automatically skipping over or muting a plurality of durations equal to the filter condition (block S17).

Therefore, if the filter rate of the durations to be skipped over or muted by the clearplay operation is higher than the predetermined reference filter rate (e.g., such that there is little point in reproducing the tide), the microcomputer 23 can automatically suspend a title playback operation. Accordingly, the embodiment of a replay or restriction operation can prevent a user from uselessly viewing some part of the title intermittently reproduced.

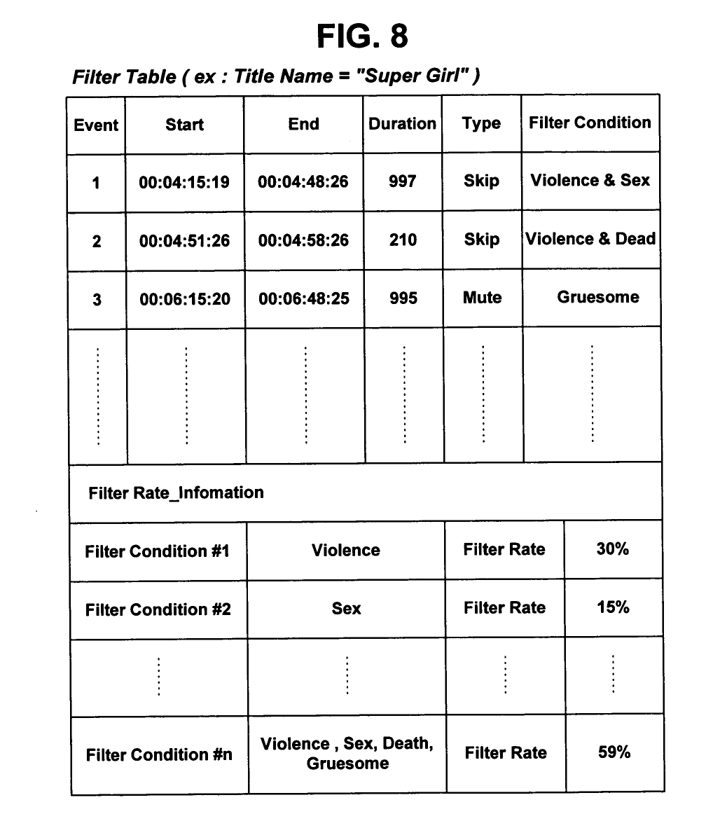

In accordance with another embodiment of the present invention, filter rate information corresponding to each of, combinations of or all the filter conditions (e.g., Violence, Sex, . . . , Violence & Sex, Death, and Gruesome) capable of being selected or determined by a user (e.g., has been previously calculated by an experimental result of a contents provider), and can be further recorded in the filter table information. An exemplary filter table according to this embodiment is shown in FIG. 8.

In this embodiment, the filter rate detector 26 may be omitted from the DVD player. The microcomputer 23 can search for a filter rate corresponding to the user-defined filter condition from among the filter table information, and compare the retrieved filter rate with a predetermined reference value.

If the retrieved filter rate is higher than the predetermined reference value, the microcomputer 23 can directly or automatically suspend the replay or clearplay operation, or control the OSD generator 24 to display an OSD image indicative of a suspended automatic playback state (e.g., “Play Auto Stop” state) as shown in exemplary FIG. 7.

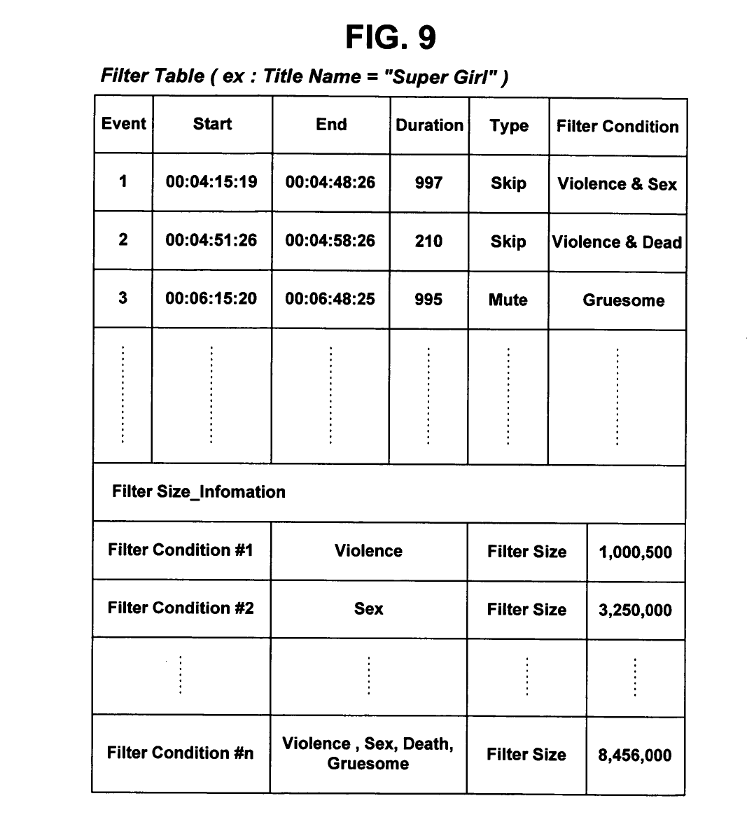

In accordance with yet another embodiment of the present invention, the filter rate information additionally recorded in the filter table information can be replaced with filter size information equivalent or equal to the sum of durations to be automatically skipped over or muted by a clearplay operation. Filter rate information according to this embodiment is shown in FIG. 9.

In other words, filter size information corresponding to all the filter conditions (e.g., Violence, Sex, . . . , Violence & Sex, Death, and Gruesome) capable of being determined by a user has been previously calculated by an experimental result of a contents provider. Such filter size information can be independently recorded in the filter table information shown in FIG. 9.

In this embodiment, the filter rate detector 26 can be omitted from the DVD player. The microcomputer 23 can search for a filter size corresponding to the user-defined filter condition from among the filter table information, and compare the retrieved filter size with a predetermined reference value. In this case, the predetermined reference value can be determined to be a reference filter size instead of the reference filter rate.

If the filter size retrieved from the filter table information is higher than the predetermined reference filter size, the microcomputer 23 can automatically suspend the replay or clearplay operation, or control the OSD generator 24 to display an OSD image indicative of a suspended automatic playback state (e.g., “Play Auto Stop” state) as shown in exemplary FIG. 7.

In accordance with still yet another embodiment of the present invention, filter rate information or filter size information is not additionally recorded in the filter table information, and the filter rate detector 26 for use in the DVD player can be replaced with a filter size detector (not shown).

In this case, the microcomputer 23 can control the filter size detector to detect a filter size of durations equal to a user-defined filter condition, and compare the detected filter size with a predetermined reference value. In this embodiment, the reference value can be determined to be a reference filter size instead of the reference filter rate.

If the filter size detected by the filter size detector is higher than the predetermined reference filter size, the prescribed action can occur. For example, the microcomputer 23 can automatically suspend the clearplay operation, or control the OSD generator 24 to display an OSD image indicative of a suspended automatic playback state (e.g., “Play Auto Stop” state) as shown in FIG. 7.

As described above, it should be noted that embodiments according to the present invention can be applicable to not only the DVD player, but also a variety of digital video devices. Further some terms (e.g., clearplay, playback restriction operation filter condition, filter table, filter rate, and filter size, etc.) were used in describing embodiments but can be replaced with other similar terms if necessary. However, the present invention is not intended to be so limited.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, embodiments of an apparatus and method for controlling or restricting a playback function according to the present invention have various advantages. For example, an apparatus and method for controlling a playback operation of a digital video device according to one embodiment can prevent a user from uselessly viewing some part of a title to be intermittently reproduced by a restriction or clearplay operation when the user would have difficulty in correctly recognizing contents of a corresponding title due to numerous durations, which are to be skipped over or muted according to a user-defined filter condition.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for controlling a playback operation of a digital video device, comprising:
comparing restriction information of segments of a video program with at least one restriction condition managed by the digital video device;
restricting segments of the video program according to the comparison; and
calculating a total of the restricted segments corresponding to said at least one restriction condition.

2. The method of claim 1, wherein said at least one restriction condition information is determined by a user, and wherein the restriction information of segments are managed by the digital video device and are determined by a user.

3. The method of claim 1, comprising:
detecting a filter rate by dividing the total of durations of the restricted segments with overall duration of the video program.

4. The method of claim 3, comprising:
calculating whether the detected filter rate is higher than a predetermined reference value; and
determining whether to perform a playback operation of the video program according to the calculated result.

5. The method of claim 4, comprising:
suspending the playback operation when the detected filter rate is higher than the predetermined reference value; and
displaying a message indicative of the suspended playback operation and a menu image for entering a restriction setting mode when the playback operation is suspended.

6. The method of claim 3, comprising
generating a menu image including the detected filter rate, and displaying the generated menu image.

7. The method of claim 1, comprising:
generating a menu image including a filter size equal to a sum of durations of the restricted segments, and displaying the generated menu image on a screen.

8. The method of claim 1, comprising:
generating a filter size equal to said total;
deciding whether the filter size is higher than a predetermined reference value; and
determining whether to perform a playback operation of the selected video according to the decided result, wherein the filter size for said at least one restriction condition is for a single characteristic of the video program, a plurality of characteristics of the video program, a combination of the plurality of characteristics or a mixture of at least one characteristic and at least one combination of characteristics.

9. The method of claim 8, further comprising:
suspending the playback operation when the detected filter size is higher than the prescribed reference value; and
displaying a message indicative of the suspended playback operation and a menu image for entering a restriction setting mode when the playback operation is suspended.

10. A method for controlling a playback operation of a digital video media contents reproduction device, comprising:
searching for management information of a plurality of durations of first media contents, reproduction of which is restricted according to at least one playback restriction condition from among a plurality of playback restriction conditions; and
determining whether to perform a playback operation of the first media contents by referring to the retrieved management information.

11. The method of claim 10, wherein the management information is individually recorded as filter rate information for the durations corresponding managed by the media contents reproduction device to each of the playback restriction conditions capable of being determined by the user or managed by the media contents reproduction device, and wherein the management information is recorded in filter table information in association with a title name or an identifier.

12. The method of claim 11, wherein the determining comprises:
automatically suspending the playback operation when the retrieved filter rate is higher than a predetermined reference value for said at least one playback restriction condition, and displaying a message indicative of a suspended playback state and a menu image for entering a restriction operation setting mode.

13. The method of claim 10, wherein the management information is individually recorded, as filter size information for the durations corresponding to each of the playback restriction conditions capable of being determined by the user, and wherein the management information is recorded in the filter table information in association with a title name or an identifier, and wherein the determining step comprises:
automatically suspending a playback operation when the filter size is higher than a predetermined reference value, and displaying a message indicative of a suspended playback state and a menu image for entering a restriction operation setting mode.

14. An apparatus for controlling a playback operation of a digital video device, comprising:
a memory configured to store filter table information required for a restricted playback operation;
a generator configured to generate an OSD (On Screen Display) menu image for use in a user interface; and
a detector configured to detect a plurality of segment durations of a selected video, reproduction of which is restricted by the restricted playback operation, and calculate a sum of the detected durations.

15. The apparatus of claim 14, wherein the detector compares the sum of the detected durations of the selected video, which are to be automatically skipped over or muted by the restricted playback operation, with an overall duration of the selected video, and detects a filter rate.

16. The apparatus of claim 15, further comprising:
a controller configured to suspend the restricted playback operation when the detected filter rate is higher than a predetermined reference value, and control the generator to display a message indicative of a suspended playback state and a menu image for entering a restricted playback setting mode, wherein the menu image includes a menu item showing the detected filter rate.

17. The apparatus of claim 14, wherein the detector detects a filter size corresponding to the sum of durations of the selected video for each of a plurality of playback restriction conditions that is to be automatically skipped over or muted by the restricted playback operation, further comprising:
a controller configured to suspend the restricted playback operation when at least one of the detected filter sizes is higher than a corresponding predetermined reference value, and controlling the generator to display a message indicative of a suspended playback state and a menu image for entering a restricted playback setting mode.

18. A digital video apparatus, comprising:
a memory configured to store filter table information required for a restricted replay operation;
a generator configured to generate an OSD (On Screen Display) menu image for use in a user interface; and
a controller configured to detect management information of a plurality of durations of first media contents reproduction of which is restricted according to at least one restriction condition of the restricted replay operation, and determine whether to perform the restricted replay operation of the first media contents by referring to the retrieved management information.

19. The apparatus of claim 18, wherein the management information is independently stored, as at least one filter condition for the segment durations corresponding to each of the restriction conditions capable of being determined by the user, and wherein the management information is stored in the filter table information in association with a title name or an identifier.

20. The apparatus of claim 19, wherein the controller automatically suspends a restricted replay operation when said at least one filter condition is higher than a corresponding predetermined reference value, and wherein the at least one filter condition includes a filter rate or a filter size.
